(19) United States
(12) Patent Application Publication
(10) Pub. No.: US 2005/0086832 A1
(43) Pub. Date: Apr. 28, 2005

(54) Air heater

(76) Inventor: Michel Declos, Montreal (CA)

Correspondence Address: Michel Declos;c/o PROTECTIONS EQUINOX INT'L INC., Suite 224, 4480, Cote-de-Liesse, Montreal, QC, H4N 2R1, CA

(21) Appl. No.: 10/693,870

(22) Filed: Oct. 28, 2003

(51) Int. Cl. F26B 11/02

(52) U.S. Cl. 34/604

(57) ABSTRACT

A heat exchanger apparatus for use with a tumble dryer. The apparatus includes a heat exchanger core portion that has hot air passageway that is connected to a tumble dryer exhaust and receives a volume of hot humid air. The hot air passageway has a first heat exchange area. An ambient air passageway has an inlet opening that receives a volume of ambient air and has a second heat exchange area that is in contact with the first heat exchange area and is generally orthogonal relative to it. The ambient air is drawn into the second heat exchange area and is heated by the hot air moving in the first heat exchange area. Both passageways are disposed in the heat exchanger core, which is sufficiently narrow to fit into a limited area surrounding the tumble dryer.

### FIELD OF THE INVENTION

The present invention concerns air heaters and more particularly to an air heater for use with a tumble dryer.

### BACKGROUND OF THE INVENTION

Tumble dryers are commonplace in the home and in commercial Laundromat's and are used to quickly dry damp articles, such as clothing and the like. Tumble dryers include a housing in which is mounted a perforated drum that is mounted for rotation in the housing. A heating element, which is typically electrically driven heat the air around the articles as they tumble in the dryer. An air duct passes the hot and humid air from the drum and is often vented outside. The hot exhaust air, often with lint and other particulates suspended therein, is vented to the outside and lost. The amount of heat generated is significant and if recovered, could be used to heat a room in a house. This would improve the energy efficiency of a house along with a decrease in heating costs to the family.

A few designs of heat recovery devices exist, an example of which is as follows:
U.S. Pat. No. 5,117,563 issued Jun. 2, 1992 to Castonguay for “Heat Recuperator from Clothes Dryer”.

The aforesaid design suffers from a number of important drawbacks. Disadvantageously, the design is bulky and complex and appears to be restricted for heating a below floor space such as a basement. The design may not be appropriate for use in confined spaces such as in closets or for tumble dryers stack on washing machines. The design includes a box-like heat exchanger mounted in a housing in a diamond-like configuration and features restricted pathways of both ambient air and hot exhaust air into a variety of compartments within the housing. The compartmentalization may be an inefficient way to introduce ambient air into the heat exchanger and if the corners of the heat exchanger are not properly sealed, may cause inefficient heating of the ambient air by the hot exhaust air.

Thus, there is a need for an improved room heater using heat recovered from a tumble dryer.

### SUMMARY OF THE INVENTION

The invention reduces the difficulties and disadvantages of the prior art by providing a compact and narrow air heater that can be used at the side of a conventional tumble dryer to direct heated lint-free air, generated by the tumble dryer, into a room of a house. To achieve this, the air heater includes a novel narrow shaped heat exchanger that has an open elongate ambient air intake face that draws cool ambient air thereinto along a non-restricted path of travel when the tumble dryer is operated and heats the ambient air using well known heat exchange technology. The heat exchanger can be easily and conveniently retrofitted to conventional tumble dryers. Moreover, the heat exchanger is easily adaptable to tumble dryers in which the exhaust outlets are located generally inaccessible areas and as such, the heat exchanger can be adapted to fit behind the tumble dryer or by the side in a limited space.

In accordance with a first aspect of the present invention, there is provided a heat exchanger apparatus for use with a tumble dryer, the apparatus comprising: a heat exchanger core portion that includes a hot air passageway connected to a tumble dryer exhaust for receiving a volume of hot humid air and having a first heat exchange area, and an ambient air passageway having an inlet opening for receiving a volume of ambient air and having a second heat exchange area in contact with the first heat exchange area and generally orthogonal relative thereto, the ambient air being drawn into the second heat exchange area of the ambient air passageway and heated by the hot air moving in the first heat exchange area; the hot air passageway and the ambient air passageway being disposed in the heat exchanger core portion that is sufficiently narrow to fit into a limited area surrounding the tumble dryer.

Typically, the first heat exchange area and the second heat exchange area are sandwiched between a first sidewall and a second sidewall, the first sidewall being disposed towards the tumble dryer and the second sidewall being disposed away from the tumble dryer. The first heat exchange area includes a plurality of hot air channels and the second heat exchange area includes a plurality of ambient air channels. The hot air channels are sandwiched between alternate ambient air channels and are in intimate contact therewith along a substantial portion of the first and second heat exchange areas.

Typically, each of the ambient air channels include a pair of spaced apart channel sidewalls and a spacer web disposed therebetween to subdivide the ambient air channels into a plurality of ambient air sub-channels.

Typically, the heat exchanger core portion includes an inner sidewall and an outer sidewall, one ambient air channel being sealingly connected to an inwardly facing sidewall surface of each of the inner and outer sidewalls.

Typically, the ambient air passageway further includes a room heater outlet located downstream from the inlet opening. The inlet opening includes a front upper intersection located at a front first corner of an upper core portion and a front lower intersection located at a front second corner of a lower core portion. The room heater outlet includes a rear upper intersection located at a rear first corner of the upper core portion and a rear lower intersection located at a rear second corner of the lower core portion.

Typically, the ambient air channels and the hot air channels are sealed into a sealing compound that extends across each of the upper and lower intersections.

Typically, a first airtight seal is located at a front portion of each of the hot air channels, the first airtight seal extending between the front upper and lower intersections.

Typically, a second airtight seal is located at a rear portion of each of the hot air channels, the second airtight seal extending between the rear upper and lower intersections. The first and second airtight seals are a plurality of spacer pads that are positioned generally orthogonal to the spacer webs. The spacer pads and the spacer webs are each sealingly connected to the front and rear intersections.

Typically, a room heater conduit is connected to the room heater outlet. A fan is rotatably connected to the room heater conduit.

Typically, a tapered chimney is removably connected to a hot air passageway outlet located downstream from the tumble dryer exhaust. The tapered chimney, when in use, is sealingly mounted on the upper edges of the upper core portion.

Typically, the inlet opening is a generally elongate rectangular unrestricted opening defined by the inner sidewall, the outer sidewall, and the sealed front intersection.

Typically, the length of the hot air channels are generally double the length of the ambient air channels.

Typically, the apparatus is a narrow, rectangular structure.

Typically, the heat exchanger core portion is removable.

### BRIEF DESCRIPTION OF THE FIGURES

Further aspects and advantages of the present invention will become better understood with reference to the description in association with the following Figures, wherein:

FIG. 1 is a simplified perspective view of an embodiment of an air heater connected to a side of a tumble dryer;

FIG. 2 is a longitudinal section view taken along line 2-2 of FIG. 1;

FIG. 3 is a detailed view of a heat exchanger;

FIG. 4 is simplified perspective view of an alternative embodiment of an air heater connected to a rear of the tumble dryer; and

FIG. 5 is a diagrammatic representation of air flow in the air heater.

### DETAILED DESCRIPTION OF THE PREFERRED EMBODIMENTS

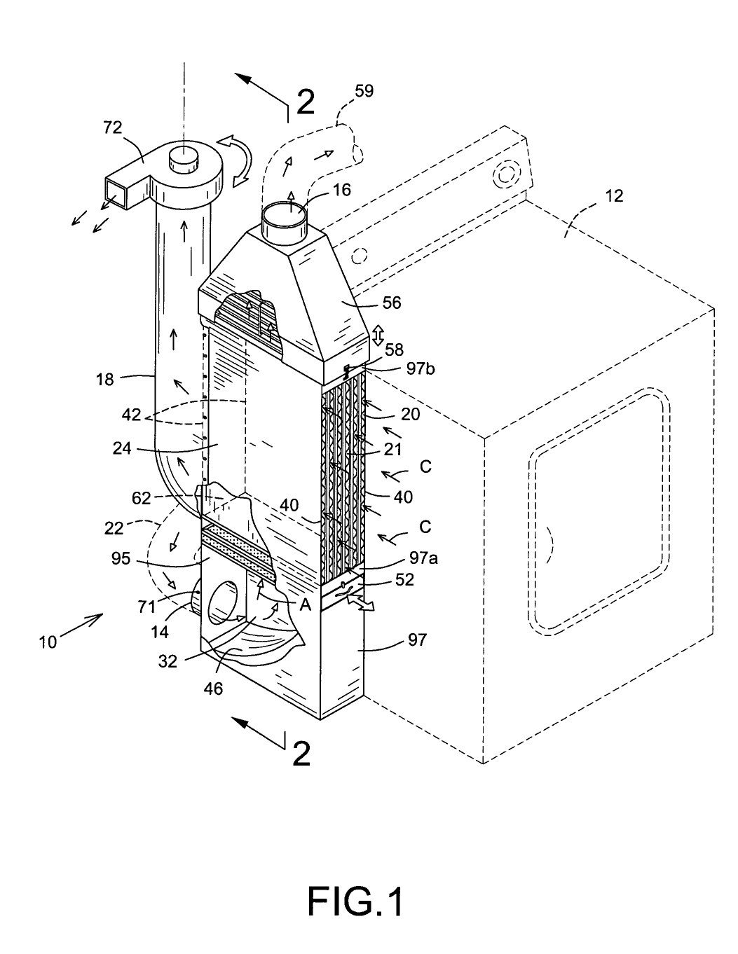

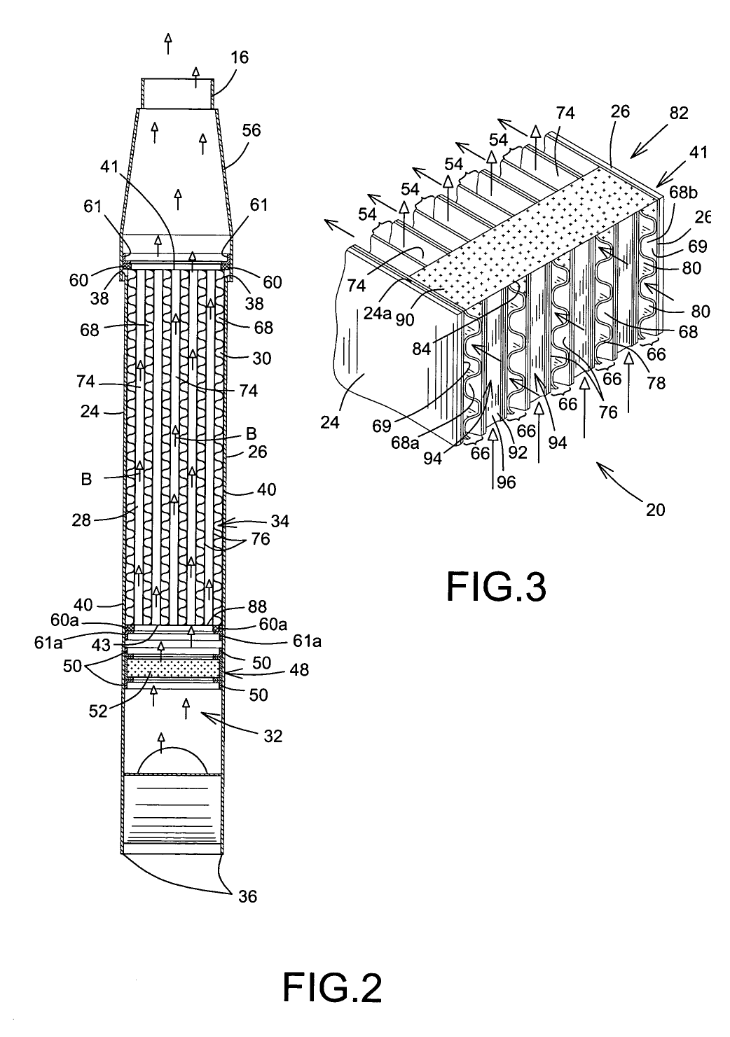

Referring now to FIGS. 1 and 2, an embodiment of a heat exchanger apparatus, illustrated generally at 10, is used to recover heat from the hot air exhaust of a tumble dryer 12. Typically, the heat exchanger 10 is located adjacent the tumble dryer 12 on either side thereof. Broadly speaking, the heat exchanger 10 includes a hot air inlet 14, an exhaust outlet 16, a room heater conduit 18 and an inlet opening 20, which is typically unrestricted. The hot air inlet 14 is connected to a tumble dryer exhaust outlet 22, which may be a hose connected to a conventional stacking model or floor model of the tumble dryer 12 known to those skilled in the art. Conventional hoses with a 4-inch (10 cm) diameter are typically used in this application.

The heat exchanger 10 has a core portion 21, which may be removable to allow for routine cleaning and maintenance, and which includes a hot air passageway 28 and an ambient air passageway 30 sandwiched between an outer sidewall 24 and an inner sidewall 26. Both the sidewalls 24, 26 extend the length of the heat exchanger 10, the inner sidewall 26 being disposed adjacent one of the tumble dryer sides, while the outer sidewall 24 is disposed away from the tumble dryer side. The sidewalls 24, 26 are spaced apart and include an intersection 48 that divides the heat exchanger 10 into a lower compartment 32 and an upper compartment 34, which houses the core portion 21. Typically, the sidewalls 24, 26 are polygonal panels, specifically square or rectangular shaped panels. Each of the sidewalls 24, 26 include a lower end 36, an upper end 38, a front end 40 and a rear end 42. The core portion 21 includes an upper core portion 41, a lower core portion 43, an outer core sidewall 24a and an inner core sidewall 26a. The outer core sidewall 24a and the inner core sidewall 26a lie snuggly against their respective inner and outer sidewalls 24, 26.

The lower compartment 32 receives a volume of the hot humid air, illustrated by arrows A, from the tumble dryer exhaust outlet 22, which is connected to a tumble dryer exhaust (not shown). The lower compartment 32 includes a deflector wall 46, which curves upwardly to deflect the hot humid air upwards into the upper compartment 34. The intersection 48 includes two pairs of runners 50 on which a removable lint collector tray 52 is slidably mounted. One skilled in the art will recognize that the lint collector tray 52 is air permeable and includes a mesh, often a wire mesh, that collects lint or any other particulate matter that can be removed and cleaned when clogged.

Referring now to FIGS. 1, 2, 3 and 5, the hot air passageway 28 defines a path of travel (illustrated by arrows B) for the hot humid air traveling from the exhaust outlet 22 across a first heat exchange area 54 of the hot air passageway 28, located in the core portion 21, above the lint collector tray 52, between the inner sidewall 26 and the outer sidewall 24, to the exhaust outlet 16. A tapered chimney structure 56 is removably connected to the upper core portion 41 and is located downstream therefrom. A pair of latches 58 (only one is shown for clarity) enables the chimney structure 56 to be quickly and easily removed from the top of the heat exchanger 10 for routine maintenance and cleaning. An exhaust conduit 59 can be attached to the chimney structure 56 to vent the exhaust air to the outside of the room. A ledge 61 with a seal 60 is attached to the periphery of the inner surface of the lower part of the chimney 56 and, when the latches 58 are in the locked position, forms an airtight seal between the chimney 56 and the upper core portion 41.

The core portion 21 includes the inlet opening 20 and a room heater outlet 62 located downstream from the inlet opening 20 and which defines the ambient air passageway 30. The ambient air passageway 30 receives a volume of ambient air (as illustrated by arrows C) into the inlet opening 20, which travels across a second heat exchange area 66 of the ambient air passageway 30, which is located between the inner and outer sidewalls 24, 26. The second heat exchange area 66 is located generally orthogonal to the first heat exchange area 54 such that the ambient air passageway 30 is in intimate contact with the hot air passageway 28.

Referring now to FIGS. 1, 2 and 3, the second heat exchange area 66 includes a number of spaced apart ambient air channels 68, which run generally horizontal to the ground from the ambient air inlet 20 to the room heater outlet 62. The room heater conduit 18 is connected to the room heater outlet 62 and includes a fan 72, which is used to draw cool ambient air from the room through the inlet opening 20 and through the ambient air passageway 30. In this embodiment, the fan 72 is rotatably connected to the room heater conduit 18 and may be used to pump the heated air from the second heat exchange into the room when required. One skilled in the art will recognize that during times when no room heating is needed, such as during warm weather, the fan 72 may be switched off and the room heater conduit 18 fed outdoors. The rotatable fan 72 may include a temperature sensor 71, attached to either the exhaust outlet 22 or the hot air inlet 14 and which activates the fan 72 when a predetermined temperature is reached within the hot air passageway 28. One skilled in the art will also recognize that the fan 72 may also be fixably attached to the room heater conduit 18 to allow the heated air to be directed into a specific area.

The spaces between ambient air channels 68 define a number of hot air channels 74 in the first heat exchange area 54, which run generally vertical to the ground and orthogonal to the ambient air channels 68. In this embodiment, the hot air channels 74 are sandwiched between alternate ambient air channels 68 and are in intimate contact with them along a substantial part of the air passageways 28, 30. Each of the ambient air channels 68 includes a pair of spaced apart channel sidewalls 76 and a spacer web 78 disposed therebetween, which subdivides the ambient air channels 68 into a number of ambient air sub-channels 80. The spacer webs 78 that are located adjacent the core outer sidewall 24a and the core outer sidewall 26a are typically sealed against an inwardly facing sidewall surface 69 and define respectively ambient air channels 68a, 68b.

Referring specifically now to FIG. 3, the inlet opening 20 of the present invention includes a front upper intersection 82 located at a front first corner 84 of the upper core portion 41 and a front lower intersection (not shown) located at a front second corner 88 of the lower core portion 43. The room heater outlet 62 includes corresponding rear upper and lower intersections of the upper and lower core portions 41, 43 and will not be described in detail. The ambient air channels 68 and the hot air channels 74 are sealed across the front upper intersection 82, between the sidewalls 24a, 26a and are sealed across the lower intersection, between the sidewalls 24a, 26a, using a flexible, heat resistant sealing compound 90 known to those skilled in the art. In a similar fashion, the sealing compound 90 also seals the rear upper and lower intersections (not shown).

At a front portion 92 of the hot air channels 74, located adjacent the inlet opening 20, an airtight seal 94 extends between the front upper intersection 82 and a similar front lower intersection. A similar airtight seal also extends between the rear upper and lower intersections. The airtight seal 94 includes a spacer pad 96 that lies orthogonal to the spacer web 78, between adjacent ambient air channel sidewalls 76 and is sealed, for example by glue or some other means thereto, to prevent the hot air in the hot air channels 74 from laterally exiting the hot air channels 74. The spacer pad 96 is sealed in the sealing compound 90 at the intersections to prevent hot air from escaping from the hot air channels 74 into the adjacent ambient air channels. An identical arrangement is found also at the intersections of the hot air channels located in the room heater outlet. The ends of the spacer web 78 are embedded in the sealing compound 90 at the intersections and the body of the spacer web 78 is melted into the ambient air channel sidewalls 76.

As best seen in FIG. 2, a ledge 61a with a seal 60a is attached peripherally to the inner surfaces of the inner sidewall 26, the outer sidewall 24, a rear sidewall 95 and a front sidewall 97 located in the upper compartment 34, and forms a an airtight seal with the lower core portion 43. The ledge 61a is generally located about one third of the distance away from the lower sidewall ends 36. The inlet opening 20 is a generally elongate rectangular opening, which is defined by the inner sidewall, the outer sidewall, and the sealed front intersections. For most applications, the heat exchanger 10 is a rectangular structure that is sufficiently narrow to fit next to the side of the tumble dryer that is located in limited space. One skilled in the art will understand that the dimensions of the heat exchanger 10 will depend on the size of the enclosure in which the tumble dryer 12 is located and the clearance between the tumble dryer 12 and the wall of the enclosure.

In this embodiment, the length of the hot air channels 74 is double the length of the ambient air channels 68.

Operation

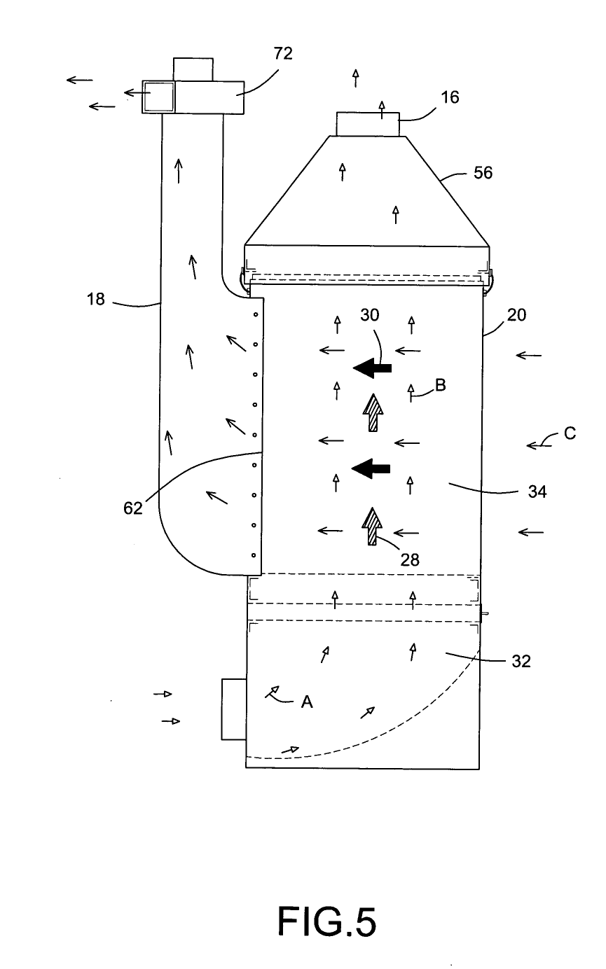

The operation of the air heater 10 will now be described with reference to FIGS. 1 and 5.

Hot and humid air exits from the tumble dryer via the tumble dryer exhaust outlet 22, as illustrated by the arrows A in FIG. 5. The hot and humid air, often with a suspension of lint and other particulate matter, is driven from the tumble dryer 12 at elevated speed whereupon it enters the lower compartment 32. The curved deflector 46 deflects the air towards the lint collector 52, which collects the lint and particulate matter. The hot and humid, essentially lint-free air moves into the heat exchanger core 21 and travels along the path of travel, as illustrated by arrows B. Either the operator or the temperature sensor 71 activates the fan 72, which draws the cool ambient air through the inlet opening 20 into the second heat exchange area 66 along the ambient air channels 68. The hot humid air flowing in the hot air channels 74 flows into the first heat exchange area 54 and transfers its thermal energy to the ambient air and heats it to a temperature above ambient temperature. The ambient air at the elevated temperature travels through the room heater outlet 62 to the room heater conduit 18, is directed into the room by the fan 72, and warms the room. Exhaust air exits the hot air channels 74 via the exhaust outlet 16 through the tapered chimney 56.

Alternatives

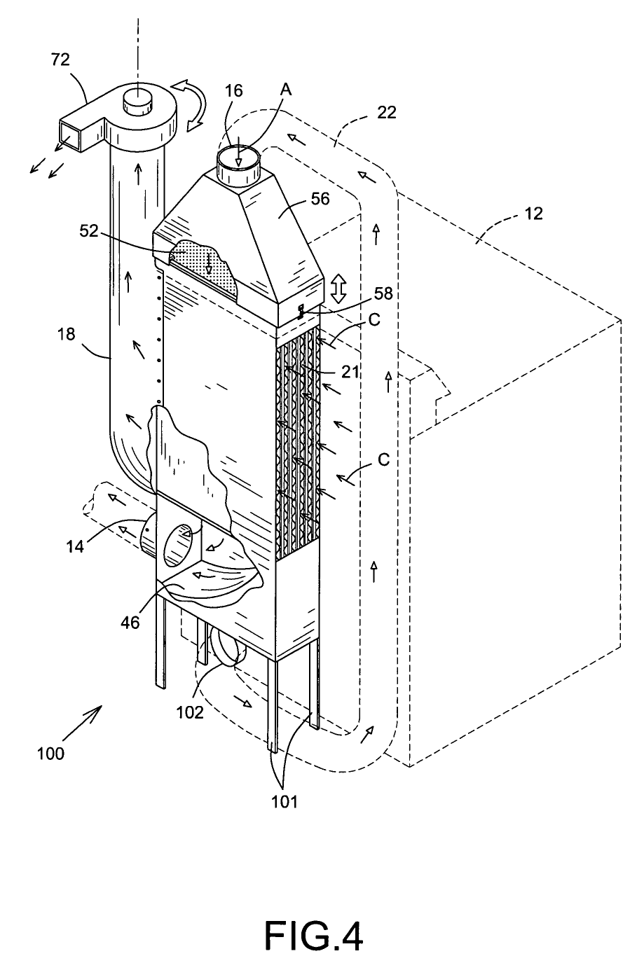

Some locations may not be accessible to the heat exchanger of the first embodiment 10. If the operator wishes to use the heat exchanger 10 of the present invention with a tumble dryer in a confined space, such as in a closet or a small apartment where there is only sufficient room at the back of the tumble dryer, an alternative heat exchanger 100 may be used as illustrated in FIG. 4.

The heat exchanger 100, illustrated in FIG. 4, is essentially identical to that of the first embodiment 10, yet the direction of flow of the hot air from the tumble dryer 12 is reversed and the heat exchanger 100 is mounted on legs 101. The exhaust outlet 22 is connected to an exhaust 102 of a tumble dryer and is connected to the tapered chimney 56. The legs 101 provide access to the exhaust outlet 22 and allow greater accessibility to the tapered chimney 56 for routine maintenance. The removable lint collector tray 52 is located at the upper end of the core 21 and within easy reach for cleaning after the latches 58 are unlocked. Hot humid air moves along the direction as illustrated by arrows A and transfers its thermal energy to the ambient air being drawn into the inlet opening 20, as illustrated by arrows C. The exhaust air exits through the hot air inlet 14 and the heated ambient air moves into the room heater conduit 18 as described above. As with the first embodiment, the heat exchanger 100 is typically a narrow, rectangular structure that is sized to fit behind the tumble dryer 12 within the typical 4 to 6 inch wide spacing between the tumble dryer 12 and an adjacent wall of an enclosed space (not shown).

One skilled in the art will also recognize that although the embodiments illustrated herein include inner and outer sidewalls 24, 26 between which the core portion is sandwiched, the sidewalls 24, 26 may be replaced by a number of angles located at the edges of the core portion 21 to secure it in place. Also, to prevent the inner and outer sidewalls 24, 26 from collapsing in on each other, several spacer strips 97a, 97b, as best illustrated in FIG. 1, space the sidewalls apart to allow the core portion to be easily inserted therebetween and removed therefrom.

While specific embodiments have been described, those skilled in the art will recognize many alterations that could be made within the spirit of the invention, which is defined solely according to the following claims.

1. A heat exchanger apparatus for use with a tumble dryer, the apparatus comprising:
a heat exchanger core portion that includes a hot air passageway connected to a tumble dryer exhaust for receiving a volume of hot humid air and having a first heat exchange area, and an ambient air passageway having an inlet opening for receiving a volume of ambient air and having a second heat exchange area in contact with the first heat exchange area and generally orthogonal relative thereto, the ambient air being drawn into the second heat exchange area of the ambient air passageway and heated by the hot air moving in the first heat exchange area;
the hot air passageway and the ambient air passageway being disposed in the heat exchanger core portion that is sufficiently narrow to fit into a limited area surrounding the tumble dryer.

2. The apparatus, according to claim 1, in which the first heat exchange area and the second heat exchange area are sandwiched between a first sidewall and a second sidewall, the first sidewall being disposed towards the tumble dryer and the second sidewall being disposed away from the tumble dryer.

3. The apparatus, according to claim 2, in which the first heat exchange area includes a plurality of hot air channels and the second heat exchange area includes a plurality of ambient air channels.

4. The apparatus, according to claim 3, in which the hot air channels are sandwiched between alternate ambient air channels and are in intimate contact therewith along a substantial portion of the first and second heat exchange areas.

5. The apparatus, according to claim 4, in which each of the ambient air channels include a pair of spaced apart channel sidewalls and a spacer web disposed therebetween to subdivide the ambient air channels into a plurality of ambient air sub-channels.

6. The apparatus, according to claim 5, in which the heat exchanger core portion includes an inner sidewall and an outer sidewall, one ambient air channel being sealingly connected to an inwardly facing sidewall surface of each of the inner and outer sidewalls.

7. The apparatus, according to claim 6, in which the ambient air passageway further includes a room heater outlet located downstream from the inlet opening.

8. The apparatus, according to claim 7, in which the inlet opening includes a front upper intersection located at a front first corner of an upper core portion and a front lower intersection located at a front second corner of a lower core portion.

9. The apparatus, according to claim 8, in which the room heater outlet includes a rear upper intersection located at a rear first corner of the upper core portion and a rear lower intersection located at a rear second corner of the lower core portion.

10. The apparatus, according to claim 9, in which the ambient air channels and the hot air channels are sealed into a sealing compound that extends across each of the upper and lower intersections.

11. The apparatus, according to claim 10, in which a first airtight seal is located at a front portion of each of the hot air channels, the first airtight seal extending between the front upper and lower intersections.

12. The apparatus, according to claim 11, in which a second airtight seal is located at a rear portion of each of the hot air channels, the second airtight seal extending between the rear upper and lower intersections.

13. The apparatus, according to claim 12, in which the first and second airtight seals are a plurality of spacer pads that are positioned generally orthogonal to the spacer webs.

14. The apparatus, according to claim 13, in which the spacer pads and the spacer webs are each sealingly connected to the front and rear intersections.

15. The apparatus, according to claim 14, in which a room heater conduit is connected to the room heater outlet.

16. The apparatus, according to claim 15, in which a fan is rotatably connected to the room heater conduit.

17. The apparatus, according to claim 16, in which a tapered chimney is removably connected to a hot air passageway outlet located downstream from the tumble dryer exhaust.

18. The apparatus, according to claim 17, in which the tapered chimney, when in use, is sealingly mounted on the upper edges of the upper core portion.

19. The apparatus, according to claim 18, in which the inlet opening is a generally elongate rectangular unrestricted opening defined by the inner sidewall, the outer sidewall, and the sealed front intersection.

20. The apparatus, according to claim 19, in which the length of the hot air channels are generally double the length of the ambient air channels.

21. The apparatus, according to claim 20, is a narrow, rectangular structure.

22. The apparatus, according to claim 21, in which the heat exchanger core portion is removable.
